(19) United States
(12) Patent Application Publication
(10) Pub. No.: US 2002/0039522 A1
(43) Pub. Date: Apr. 4, 2002

(54) Fastener including a screw member and a securing ring

(76) Inventors: Gunther Hartmann, Alsfeld (DE); Wolfgang Sommer, Gemunden (DE); Frank Wagner, Grossen-Buseck (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/965,336

(22) Filed: Sep. 27, 2001

(30) Foreign Application Priority Data
Oct. 4, 2000 (DE) 100 48 913.3-12

(51) Int. Cl. F16B 39/24

(52) U.S. Cl. 411/161

(57) ABSTRACT

A fastener (1) or a connecting element for connecting components includes a screw member (2) and a securing ring (3). The screw member (2) includes a first wrench engagement surface (5), a threaded portion (11) and a support surface (7). The securing ring (3) includes a second wrench engagement surface (9), a counterpart support surface (13) facing the screw member (2) and a contact surface (15) being designed and arranged to transmit an axial force to a component in the mounted position of the fastener (1). The securing ring (3) is rotatably connected to the screw member (2). The support surface (7) faces the securing ring (3), it is designed and arranged to transmit an axial force to the securing ring (3) and it includes a first taper-surface tooth arrangement (8) being designed and arranged to be operative in both directions of rotation. The counterpart support surface (13) includes a respective second taper-surface tooth arrangement (14) being designed and arranged to be operative in both directions of rotation.

### CROSS REFERENCE TO RELATED APPLICATIONS

This application claims the benefit of co-pending German Patent Application No. 100 48 913 entitled “Lösbares Verbindungselement für ein Bauteil, mit einem Schraubteil und einem Sicherungsring”, filed on Oct. 4, 2000.

### FIELD OF THE INVENTION

The present invention generally relates to a fastener or a releasable connecting element or unit for a component. The fastener includes a screw member and a securing ring. The fastener can be used generally in relation to connecting components. It can also be employed in particular in conjunction with a wheel bolt or wheel nut, in which therefore the wheel bolt or the wheel nut represents the screw member, with each of which a respective securing ring is then also associated.

### BACKGROUND OF THE INVENTION

A releasable connecting element is generally known in the form of a head screw as a screw member. A support washer, a locking washer or the like forms a securing ring. The securing ring is arranged rotatably with respect to the screw member. The screw member has a first wrench engagement face, a screwthread portion and a support face for transmitting the axial force to the securing ring. The securing ring has a counterpart support face and a contact face for transmission of the axial force to the component.

Another releasable connecting element is known in the context of a specific use from European Patent Application No. 0 836 016 A2. The known connecting element has as the screw member a wheel screw or bolt and a support ring. The wheel screw has a head and a shank which is provided with a screwthread portion. The support ring only limitedly performs a securing function; it serves primarily for improved transmission of the axial force of the wheel screw. On the side towards the support ring the head of the wheel screw has a support face for transmitting the axial force to the support ring. That support face is in the form of a flat face. In association therewith, the support ring has a counterpart support face which is also flat. On the other hand, the support ring, on the side towards the vehicle wheel, has a contact face which is frustoconical or also of a spherical configuration, that is to say which is not flat, for transmitting the axial force to the vehicle wheel. The support ring is mounted rotatably to the wheel screw by way of at least one peening portion and is thus non-losably held in place. Generally four peening portions are arranged distributed around the periphery. The support ring is intended to be connected to the wheel screw by way of those peening portions in such a way that the support ring is still rotatable on the shank of the wheel screw and thus there is little friction between the support ring and the head of the screw when the wheel is fixed in place. The support ring can include a light metal alloy while the wheel screw is made of steel. In that way, in conjunction with a vehicle wheel made of magnesium, contact corrosion between the support ring and the vehicle wheel is avoided. It may be desirable for the connecting element to be of such a configuration that as little friction as possible occurs between the support ring and the screw head when fixing the wheel in place. That low level of friction however is a disadvantage in terms of the wheel screws coming loose of their own accord. Particularly when a transverse loading is involved, such connecting elements run the risk of coming loose of their own accord. That risk is particularly significant if increasing engine output levels and vehicle weights are to be taken into account and if it is considered that those connecting elements are subjected to a considerable transverse loading upon acceleration and braking. In addition, there is the risk of such known connecting elements settling, in particular due to the oscillations and vibration which inevitably occurs on a vehicle, whereby the axial force is reduced. The result of this is that, when a corresponding transverse loading is applied, such connecting elements can then come loose of their own accord even more easily.

On the other hand, screws are known whose support face is provided under the head of the screw in a particular fashion in order to alleviate the risk of the assembly coming loose of its own accord when a loading is involved. In that respect, the support surface under the head is provided with a taper-surface tooth arrangement which is of such a configuration and design that the screw can be comparatively easily tightened insofar as correspondingly shallowly inclined surfaces of the taper-surface tooth arrangement slide over the component, while, after the screw has been tightened and under load, the tooth dig into the material of the component to be screwed in place and thus give rise to an increased level of resistance which has to be applied or overcome when releasing and when unscrewing the screw. Therefore, the aim of that taper-surface tooth arrangement is to permit the support surface to slide against the component when the screw is being tightened, but in contrast, upon loosening of the screw and when unscrewing it, as far as possible to afford conditions which require an increased release and unscrewing moment in order so-to-speak to overcome a positively locking engagement. The material pairing between the screw and the component also has to be matched to each other. It will be appreciated that only the screw has a taper-surface tooth arrangement while the component has a flat or smooth contact face. In that way, the screw is generally effectively prevented from coming loose of its own accord by virtue of the increase in the friction between the support face of the head of the screw and the corresponding counterpart face on the component. On the other hand the screw can be intentionally unscrewed by applying a suitably increased unscrewing moment. The capacity for multiple use of such screws is limited.

German Patent Application No. 24 13 760, U.S. patent application Ser. No. 3,263,727 and European Patent Application No. 0 131 556 disclose spring ring arrangements including two securing rings which are used in conjunction with one screw. The spring ring arrangements have two spring rings which bear against each other and which can be of an identical configuration and which bear against each other in point-symmetrical relationship. Those two spring rings come to bear or are operative between the flat support face on the head of the screw and the contact face, which is also flat, on the component. On their outwardly facing surfaces, that is to say facing towards the support face on the head on the one hand and the contact face on the component on the other hand, the two spring rings have a tooth arrangement for increasing the amount of friction involved, generally in the form of radially arranged ribs or the like. The two spring rings are provided on the mutually facing faces with taper-surface tooth arrangements which are composed of inclined flat surface portions and possibly further surface portions arranged perpendicularly to the axis of the spring assembly or the screw. The inclinedly arranged surface portions are arranged to be inclined at different angles in the peripheral direction so that, when the screw is tightened, a positively locking to engagement is produced between the two spring rings or spring washers, but in the unscrewing direction the corresponding taper surfaces slide against each other in the manner of an inclined plane, in order thereby to bring about an increase in the axial force. Upon loosening or unscrewing of the connection, that increased axial force has to be overcome. Spring ring arrangements of that kind are expensive to produce and increase the number of parts to be used on a screw connection. In addition, besides the screw, it is also necessary to handle the two spring rings and above all to install them in the correct position. The spring rings are in the form of additional components which can be lost. The use of additional spring rings in connection with releasable screws entails the further disadvantage that the use thereof increases the number of separating and settling joins between the individual constituent parts of the screw assembly. The greater the number of such settling joins, the higher are the amounts of settlement caused thereby in the screw assembly so that the consequence of this can be a dangerous reduction in axial force. That is the case in particular when the elements used in the screw assembly are of a particular surface configuration, whether in the form of a corrosion-inhibiting layer, a covering or the like, and those elements are exposed under operating conditions to an elevated temperature. In the case of releasable connecting elements for fixing a vehicle wheel, such additional spring ring arrangements cannot be envisaged in any case because the corresponding contact face on the wheel dish involves a conical or spherical shape, that is to say it represents a contact face which is not flat. As such wheel screws or wheel nuts also have to be frequently loosened and tightened again, there are particular conditions which run counter to the use of a spring washer arrangement.

### SUMMARY OF THE INVENTION

The present invention generally relates to a fastener including a screw member and a securing ring. More particularly, the present invention relates to fastener including a screw member including a first wrench engagement surface, a threaded portion and a support surface. The securing ring includes a second wrench engagement surface, a counterpart support surface facing the screw member and a contact surface being designed and arranged to transmit an axial force to a component in the mounted position of the fastener. The securing ring is rotatably connected to the screw member. The support surface faces the securing ring, is designed and arranged to transmit an axial force to the securing ring and includes a first taper-surface tooth arrangement being designed and arranged to be operative in both directions of rotation. The counterpart support surface includes a respective second taper-surface tooth arrangement being designed and arranged to be operative in both directions of rotation.

The securing ring is generally connected non-losably or captively to the screw member, in particular to facilitate assembly. The connection is such that the securing ring can not only rotate relative to the screw member but radial displacement of the axes relative to each other is possible, within the limits of a motion clearance provided by the assembly. This is limited to a narrow range, as is appropriate for example for compensating for hole spacing errors in the openings in the wheel dish and/or the hub.

The novel releasable connecting element affords a securing action for the screw member, irrespective of whether the forces which act in the unscrewing direction when a loading is involved act by way of the screw member or the securing ring. The releasable connecting element or fastener includes only few individual parts to permit simple and reliable assembly. It satisfies the conditions of multi-usability.

The present invention improves the previously known releasable connecting elements in the form of head screws or nuts, in each case with a support ring, without increasing the number of parts involved. Use of the taper-surface tooth arrangements or wedge surface tooth arrangements affords an increase in the axial force in relation to loosening of its own accord, and therefore opposes loosening of the connecting element when elevated levels of loading are involved. In the case of known connecting elements, transverse forces which with a corresponding loading act on the elements of the connecting element, normally result in the screw member loosening of its own accord. By virtue of the two taper-surface tooth arrangements sliding against each other, that loosening movement is terminated, and a further drop in the biasing force is resisted. In that situation only a very severely limited relative movement takes place. Any tendency to relative movement is resisted. That will act or occur in that way many times in relation to loadings which occur many times and which are also of different magnitudes. This applies in regard to the connecting element coming loose of its own accord, for both relative directions of rotation. In one case, the loading on the connecting element in use means that the screw member seeks to turn in the unscrewing direction with respect to the securing ring which is held fast; in that case the screw member is held and secured by the fixed securing ring, with an increase in the axial force. In the other situation, the loading on the connecting element in use means that the securing ring seeks to turn in the unscrewing direction with respect to the screw member which is held fast; in this case, the securing ring is held and secured by the stationary screw member, with an increase in the axial force. In both cases finally the securing action acts on the entire connecting element including the screw member and the securing ring. Therefore, by virtue of that release movement which is inevitable when a corresponding loading occurs, in relation to transverse forces, the novel connecting element, in conjunction with the taper-surface tooth arrangements, accordingly provides for axial and tangential movement of the screw member with respect to the support ring. That advantageously results in compensation for losses in terms of biasing forces. That is the case in particular if the biasing force is already reduced due to inevitable settling phenomena and thus the amount of transverse force which can be transmitted by frictional engagement between the members which are braced in relation to each other has been reduced. A similar situation occurs if, for example due to incorrect assembly or maintenance, the connection was not tightened to the torque which is usually prescribed, and thus the level of biasing force required to provide a secure connection was not reached. In that respect the invention also represents a contribution to enhancing safety.

An essential consideration in connection therewith is that the securing ring also has a wrench engagement face. The first wrench engagement face is usually arranged on the screw member, for example in the form of a head of hexagonal cross-section on the inside or on the outside. In accordance with the invention the securing ring now also has a wrench engagement face, while support washers, toothed washers and other securing elements in the art do not have any such wrench engagement face. The arrangement of two wrench engagement faces in association with each other on two different members, more specifically on the one hand the screw member and on the other hand the securing ring, affords the meaningful possibility of jointly handling the screw member and the securing ring, that is to say jointly tightening them or unscrewing them, when deliberately actuating the connecting element, so that the taper-surface tooth configurations are not loaded relative to each other, in that active application of force, in assembly or dismantling. Conversely, in accordance with the invention, in use of the connecting element, that is to say after assembly and prior to dismantling, the effect of the taper-surface tooth arrangements is utilized in both relative directions of rotation, over the entire time of the loading acting thereon, in order to provide a securing effect to resist the assembly coming loose of its own accord. In that securing effect, a relative rotary movement which takes place of its own accord as between the screw member and the securing ring is used to permit the members to slide on each other by means of the two taper-surface tooth arrangements when they are rotated away from each other. The resulting increase in the axial force of the connecting element affords the securing effect. That applies in regard to both directions of rotation, irrespective of whether the force acting in the unscrewing direction acts primarily by way of the screw member or by way of the securing ring on the connecting element.

Allocating the first taper-surface tooth arrangement to the screw member, that is to say a head screw, a wheel screw or bolt or a wheel nut, and the second taper-surface tooth arrangement to the securing ring, does not increase the number of element used. The number of settling joins also remains the same, in comparison with known connecting elements, so that there is no need to reckon on increased amounts of settlement.

In addition the securing ring can be arranged on the wheel screw or the wheel nut in such a way that it is secured against loss. That can be achieved by means of mechanical abutments but also by an adhesive spot or the like. That affords an assembly unit which is easy to handle and which can always be and is always used complete and which can also be handled for example by robots, in particular upon initial assembly.

A further advantage of the novel fastener or connecting element or unit is that an enhanced clamping length is advantageously afforded by virtue of the use of the securing ring which, in comparison with lock washers, spring washers and the like, is of a greater structural height which is also governed by the arrangement of the second wrench engagement face. The connecting element is thus advantageously of an elastic configuration, which promotes maintenance of the axial force, in particular when settling phenomena occur in the connection. That can be further promoted for example by the choice of a more elastic material for the securing ring, in comparison with the material of the screw member.

The two taper-surface tooth arrangements are of such a configuration and design that, when force acts on the screw member or the securing ring in the unscrewing direction of the connecting element, as between the screw member and the securing ring, there is a securing action which is in opposite relationship to release of the connecting element of its own accord, wherein the screw member and the securing ring are screwed away from each other, increasing the axial force, whereas upon joint tightening and joint unscrewing, the taper-surface tooth arrangements of the screw member and the securing ring maintain their positively locking engagement. Generally, the securing action occurs to the same degree, irrespective of whether the transverse force producing the unscrewing movement acts primarily on the screw member or the securing ring. Each taper-surface tooth arrangement has shaped surfaces or form surfaces which are then arranged symmetrically in both directions. Active actuation of the connecting element, that is to say when tightening or releasing the assembly with a tool, always occurs in such a way that the screw member and the securing ring are turned jointly without mutual angular displacement. The two taper-surface tooth arrangements therefore remain in a condition of positively locking engagement when that happens. The shaped surfaces are not loaded by assembly torques. That serves in particular for multi-usability. In addition, no relative movement occurs between the screw member and the securing ring upon assembly and dismantling, and accordingly there is also no wear between the shaped surfaces of the two taper-surface tooth arrangements. The screw member and the securing ring can be produced inexpensively from standard materials, using a standard heat treatment. The configuration and arrangement of the shaped surfaces of the two taper-surface tooth arrangements is free from the necessity to achieve or maintain a condition of positively locking engagement in the peripheral or circumferential direction because the active turning force always acts at the screw member and the securing ring. This means that the teeth of the taper-surface tooth arrangements, formed by the shaped surfaces, can be of such a configuration as to be comparatively low in height.

In the two peripheral directions, on each tooth, the taper-surface tooth arrangements have at least two shaped surfaces which are arranged inclinedly in the peripheral directions, wherein to permit the sliding movement for rotating the screw member and the securing ring away from each other, the shaped surfaces which come into contact with each other in the unscrewing direction are arranged with a comparatively small mean tangential angle. It will be appreciated that the tangential angle—considered over the relevant direction—remains constant if the shaped surfaces are in the form of non-flat surfaces extending thread-like at a constant pitch or helix.

The effective tangential angle of the shaped surface of the taper-surface tooth arrangements, which come into contact with each other in the unscrewing direction of the screw member, is only slightly greater than the pitch or helix angle of the threaded portion. That applies at least in regard to the first region of the taper-surface tooth arrangements in the unscrewing direction of the screw member. Thus, the effective tangential angle of the form surfaces of the taper-surface tooth arrangements, which come into contact with each other in the unscrewing direction of the screw member, can be up to approximately 20% greater than the pitch angle of the screwthread portion. It is particularly desirable if the effective tangential angle is between approximately 3 and 20% greater than the pitch angle of the screwthread portion.

The shaped surfaces which are arranged inclinedly in the two peripheral directions can be of a symmetrical configuration and can be arranged symmetrically inclined. The symmetry is in relation to a plane through the axis of the connecting element. This embodiment is desirable if it can be seen that the transverse forces or moments causing the assembly to come loose of its same accord can act to the same degree on the screw member or the securing ring.

The shaped surfaces or form surfaces which are arranged inclinedly in the two peripheral directions however may also be of an asymmetrical configuration and/or may be arranged asymmetrically inclined. This embodiment is meaningful if it can be seen that the moments or transverse forces causing the assembly to come loose of its own accord can act on the screw member to a different degree, in comparison with the securing ring. The effective tangential angle of the shaped surfaces of the taper-surface tooth arrangements, which come into contact with each other in the unscrewing direction of the securing ring, can be less than the helix angle of the threaded portion.

The taper-surface tooth arrangements also do not have to extend over the entire region of the surfaces on the screw member and the securing ring but may also occupy only regions of those surfaces. Radially directed flat surface portions may certainly also be used. What is preferred is that the taper-surface tooth arrangements are of the same or different properties, in dependence on the respective direction of rotation. A positively locking engagement is not required. The effect of an inclined plane is used in the tightening direction of the screw member and in opposite relationship to the tightening direction, that is to say in the unscrewing direction, in order to counteract the drop in axial force.

It is further preferred that the shaped surfaces which come into contact with each other to achieve the sliding movement in the unscrewing direction are in the form of non-flat shaped surfaces extending in a screwthread-like configuration. That then provides for support over the full surface area involved in respect of the axial force of the screw member on the securing ring, such force being increased by virtue of the mutual rotary movement, this being for example in contrast to the shaped surfaces which come into contact being supported against each other in point contact or line contact.

The two taper-surface tooth arrangements and/or the contact face of the securing ring for transmission of the axial force to the component may be of such a configuration and arrangement that the torque which can be transmitted by way of the taper-surface tooth arrangements is less than the torque which can be transmitted between the securing ring and the component. That can be achieved in a number of ways. For example, the taper-surface tooth arrangement may have a low level of friction, due to a lubricant applied thereto. It is however also possible for the contact face of the securing ring to be provided with ribs, bar-like projections, a friction-enhancing coating, a sand-blasted surface or the like, to produce an increased level of friction. That condition is more easily attained if the contact surface of the securing ring against the component is of a larger frictional radius than the taper-surface tooth arrangements.

The securing ring can be arranged non-losably (captive) but movably on the screw member. The mobility relates to a possible displacement between the screw member and the securing ring in order to permit adaptation to hole spacing errors. There are various possible ways of achieving the condition of non-losability. A simple option in this respect provides that the securing ring is pushed on to the shank of the screw member and it is only then that the thread is produced by rolling on the screwthread portion. In that situation the outside diameter of the thread is larger than the inside diameter of the bore on the securing ring. Subsequently producing a securing groove, a bead or ridge or the like on the shank of the screw member by a rolling procedure is also a possibility. Peening portions on the securing ring are also possible. In particular, the screw member and the securing ring can also be connected to each other in the correct angular relationship by a spot of adhesive. The effectiveness of the spot of adhesive is essentially limited to first use of the connecting element. It ensures at the same time that the relative position in the correct angular relationship is maintained until the two wrench engagement faces are jointly engaged by a tool. On the other hand, the spot of adhesive is not intended to increase the level of torque which can be transmitted between the taper-surface tooth arrangements, to any amount worth mentioning.

The first wrench engagement face on the screw member and the second wrench engagement face on the securing ring can advantageously be designed and arranged to be in mutually aligned relationship so that they can be jointly handled with a wrench. In that relative position the two taper-surface tooth arrangements engage into each other to the maximum extent.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a view of a first exemplary embodiment of the novel fastener including a screw member and a securing ring.

FIG. 2 is a view of the screw member of FIG. 1.

FIG. 3 is a view of the securing ring of FIG. 1.

FIG. 4 is a top view of the securing ring of FIG. 3.

FIG. 5 is a view of a second exemplary embodiment of the novel fastener including a screw member and a securing ring.

FIG. 6 is a view of a second exemplary embodiment the securing ring.

FIG. 7 is a view of the screw member including an asymmetrical taper-surface tooth arrangement.

FIG. 8 is a view of the securing ring including an asymmetrical taper-surface tooth arrangement.

FIG. 9 is a top view of the securing ring of FIG. 8.

FIG. 10 is a view of another exemplary embodiment of the screw member.

FIG. 11 is a view of another exemplary embodiment of the securing ring.

FIG. 12 is a top view of the securing ring of FIG. 11.

FIG. 13 is a view of the novel fastener including a screw member and a securing ring in the form of a hollow body.

FIG. 14 is a view and a half-section of a novel fastener including a screw member in the form of a wheel nut and a securing ring.

FIG. 15 is a view of another exemplary embodiment of the novel fastener including the screw member and the securing ring.

FIG. 16 is a view of the screw member of FIG. 15.

FIG. 17 is a view of the securing ring of FIG. 15.

### DETAILED DESCRIPTION

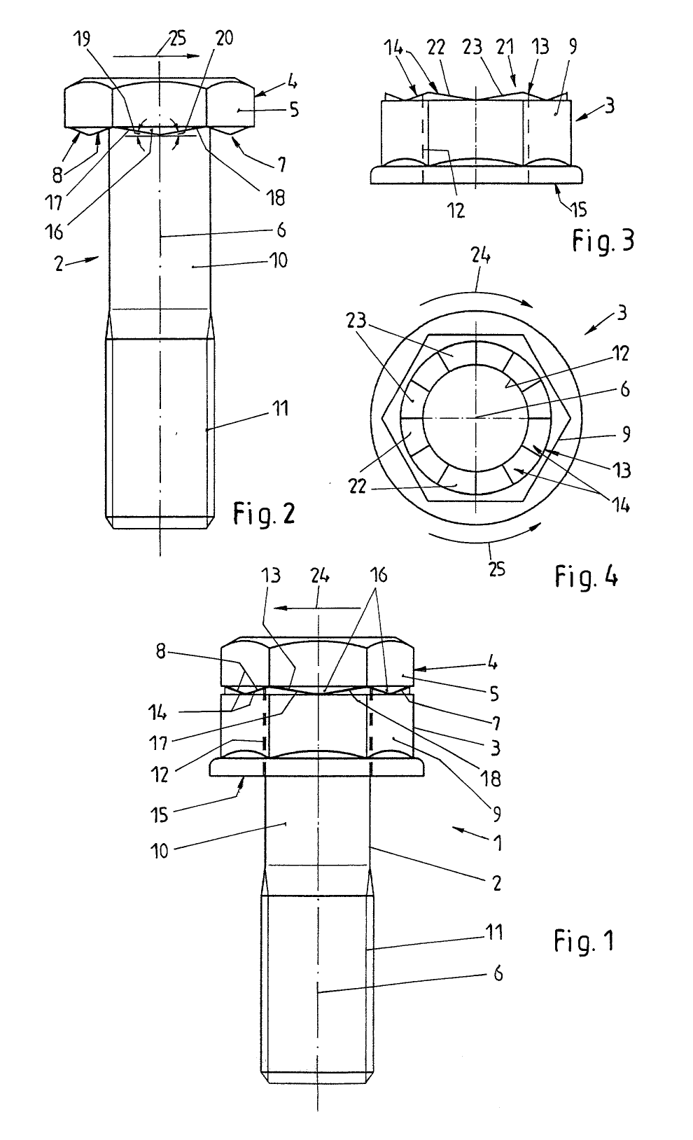

Referring now in greater detail to the drawings, FIG. 1 illustrates a first exemplary embodiment of a connecting element or fastener 1, as is used for fixing components. The fastener 1 includes a screw member 2 and a securing ring 3. The screw member 2 is here embodied in the form of a screw. The screw member 2 has a head 4 which has a first wrench engagement face 5 for the engagement of a screw wrench or a similar turning tool. The screw member 2 and the securing ring 3 have a common axis 6 or are used with a common axis 6. The head 4 of the screw member 2 goes into a support surface 7, on the underside thereof. The support surface 7 includes a plurality of surface portions which overall form a first taper-surface tooth arrangement or wedge-shaped tooth arrangement 8. The support surface 7 overall is arranged oriented perpendicularly to the axis 6 of the connecting element 1. The support surface 7 or the first taper-surface tooth arrangement 8 is adjoined by a shank 10 which is arranged, beginning at the end, with a threaded portion 11 with which the connecting element 1 including the screw member 2 and the securing ring 3 is screwed into a corresponding counterpart thread on the component.

The second part of the fastener 1 is the securing ring 3. The securing ring 3 is an annular body. It has a second wrench engagement surface 9. The wrench engagement surfaces 5 and 9 can be arranged in any conceivable manner whatever, that is to say for example in the form of a hexagon, a square, of non-round cross-section and the like. It is meaningful in terms of simplicity of actuation however if the two wrench engagement surfaces 5 and 9 are of the same configuration and are disposed in mutual alignment. The securing ring 3 also has in alignment with the axis 6 a bore 12 (see FIGS. 1, 3 and 4). If the bore 12 is of a larger diameter than the outside diameter of the threaded portion 11, the parts can be brought together immediately prior to assembly. If the bore 12 is of a smaller diameter than the outside diameter of the screwthread portion 11 and of a larger diameter than the diameter of the shank 10, the parts can be brought together during manufacture and before the thread is produced on the threaded portion 11 by rolling. That then results in an assembly unit in which the securing ring 3 is held to the screw member 2 in such a way that it cannot be lost therefrom.

On its top side, that is to say facing towards the head of the screw member 2, the securing ring 3 has a counterpart support surface 13 which corresponds to the support surface 7 of the screw member 2. Arranged on the counterpart support face 13 is a second taper-surface tooth arrangement 14 which is matched to the first taper-surface tooth arrangement 8 of the screw member 2.

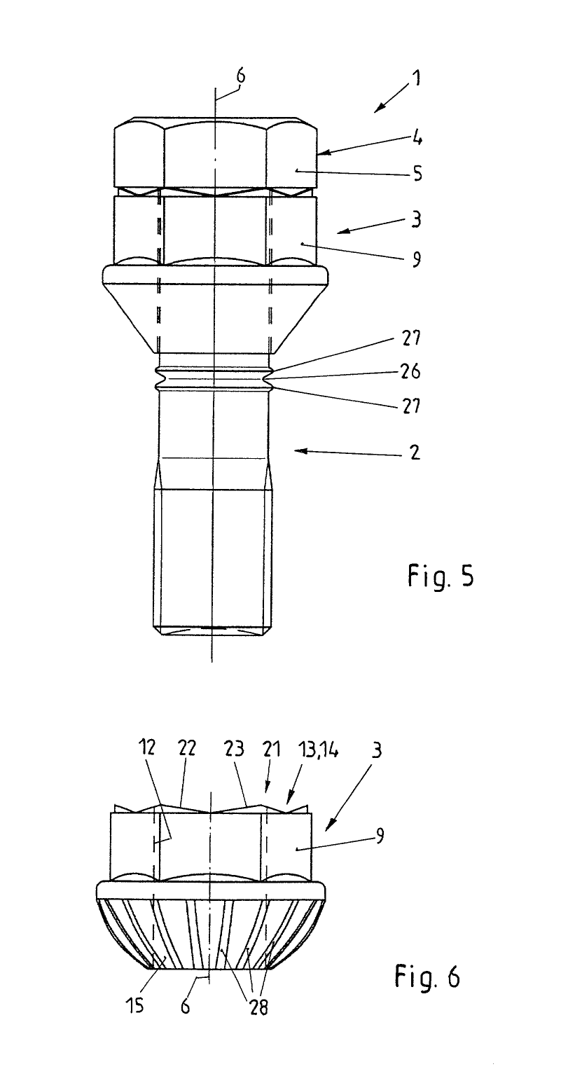

On its underside, that is to say in the assembled condition facing towards the screwthread portion 11 of the screw member 2, the securing ring 3 has a contact surface 15 which is in the form of a flat surface (FIGS. 1 and 3) but which can also be of a crowned or spherical or conical configuration (see FIGS. 5, 6 and 11).

It is already possible to see from FIG. 1 that the two mutually associated taper-surface tooth arrangements 8 and 14 are for example symmetrical relative to each other in terms of their configuration and arrangement. The two taper-surface tooth arrangements 8 and 14 engage to the maximum extent into each other in positively locking relationship at such a relative angular position as between the screw member 2 and the securing ring 3, at which the wrench engagement surfaces 5 and 9 are aligned with each other in the direction of the axis 6. When the connecting element 1 is tightened and unscrewed, the screw member 2 and the securing ring 3 are turned jointly, in particular using a single screw wrench which is of a suitably wide size. Therefore, a procedure for fixing a component involves turning the screw member 2 (with a right-hand thread) and the securing ring 3 in the normal right-hand direction in the direction as indicated by the arrow 24 in FIGS. 1 and 4. Conversely, the screw member 2 and the securing ring 3 are turned jointly when unscrewing the connecting element in the direction of rotation indicated by the arrow 25 (FIGS. 2 and 4). In that situation the taper-surface tooth arrangements 8 and 14 do not perform any relative movement with respect to each other. When the connecting element is intentionally tightened or unscrewed, no wear and also no plastic deformation occurs. That is advantageous in terms of re-usability of the connecting element. In use of the assembled connecting unit or fastener 1, transverse forces can act on the screw member 2 or the securing ring 3, which manifest themselves in a relative turning movement of the screw member 2 and the securing ring 3. If the transverse forces act on the screw member 2 the latter rotates with respect to the stationary securing ring 3 in the direction of rotation 25 which at the same time represents the unscrewing direction of the connecting element. If the transverse forces act on the securing ring 3 the securing ring 3 rotates with respect to the stationary screw member 2 in the direction of rotation 25 or in the direction of rotation 24, which corresponds to a relative rotary movement of the screw member 2 with respect to the securing ring 3 in the direction of rotation 24 or 25 respectively. In both situations, the taper-surface tooth arrangements 8 and 14 slide against each other, with the head 4 moving axially away from the securing ring 3 in the direction of the axis 6.

The connecting element 1 shown in FIG. 1 can be loosely assembled if the diameter of the bore 12 is larger than the outside diameter of the screwthread portion 11. The securing ring 3 is thus removably arranged on the screw member 2. The securing ring 3 however can also be non-losably (captive) held to the screw member 2. In both cases the securing ring 3 is arranged rotatably with respect to the screw member 2.

In particular, the first taper-surface tooth arrangement 8 on the screw member 2 will be further illustrated and described with reference to FIGS. 1 and 2. In the illustrated exemplary embodiment, the contact surface 7 or the first taper-surface tooth arrangement 8 has six teeth 16 which are of a symmetrical configuration and arrangement. In this respect, it is immaterial whether the threaded portion 11 is a right-hand thread or a left-hand thread. The only difference is that the respective other one of the two directions of rotation 24 and 25 is the unscrewing direction. Each tooth 16 includes two shaped surfaces or form surfaces 17 and 18. The form surfaces 17 extend in a radial direction with respect to the axis 6. The form surfaces 17 and 18 are in the form of non-flat surfaces extending in a screwthread-like configuration and intersect each other at edges, the prolongations of which intersect the axis 6. The inclinedly arranged form surfaces 17 and 18 are arranged with approximately identical tangential angles 19 and 20 (see FIG. 2). The angles 19 and 20 may also be of different magnitudes. At least the angle 20 should be slightly larger than the helix angle of the thread of the screwthread portion 11. Here, the principle of the inclined plane, which is required for the sliding movement in the unscrewing direction, is embodied in both relative directions of rotation 24 and 25. In this case, the shaped surfaces 17 and 18 are in the form of non-flat surfaces extending in a screwthread-like configuration and which extend approximately from the edge of the head 4 radially inwardly almost as far as the shank 10 of the screw member 2. As a result of the shaped surfaces 17 and 18 being in the form of non-flat surfaces of constant pitch or gradient, there is over the relative rotational travel only one respective effective tangential angle 19 and 20 respectively, independently of the respective rotational position as between the screw member 2 and the securing ring 3. The angle 20 is greater than the pitch angle of the thread of the screwthread portion 11 of the screw member 2.

FIGS. 3 and 4 are detailed views showing the securing ring 3 with its complementary configuration of the counterpart support surface 13 and the second taper-surface tooth arrangement 14. The taper-surface tooth arrangement 14 also has six teeth 21 which are arranged distributed over the periphery or circumference in association with the wrench engagement surface 9. Each tooth 21 includes two shaped surfaces or form surfaces 22 and 23. The shaped surfaces 22 of the securing ring 3 are of a configuration and arrangement corresponding to the shaped surfaces 17 of the screw member 2. The shaped surfaces 23 of the securing ring 3 are of a configuration and arrangement corresponding to the shaped surfaces 18 of the screw member 2. The shaped surfaces 22 and 23 are thus also arranged in identical tangential angles 19 and 20 and extend radially and perpendicularly with respect to the axis 6 so that in this case also the prolongations of the shaped surfaces 22 and 23 intersect the common axis 6 of the connecting element 1. In this first embodiment the shaped surfaces 22 and 23 are also in the form of non-flat surfaces which are provided with a constant pitch in the manner of a screwthread, so that constant tangential angles 19 and 20 are used, irrespective of the relatively rotated position in which the screw member 2 is disposed with respect to the securing ring 3.

In general terms a plurality of fasteners or connecting elements 1 are required to fix a component. A securing ring 3 is fitted on to a screw member 2 in the relative position which can be seen from FIG. 1. There are six such relative positions in which a condition of maximum positively locking engagement exists and at the same time the wrench engagement surfaces 5 and 9 are in mutual alignment. The screw member 2, together with the securing ring 3, is then screwed with the screwthread portion 11 through the corresponding opening in the component into a counterpart screwthread. In that situation, the screw member 2 and the securing ring 3 are turned or screwed in, as a joint unit. There is a condition of maximum positively locking engagement between the taper-surface tooth arrangements 8 and 14, that is to say the securing ring 3 and the head 4 of the screw member 2 are at the smallest possible distance away from each other in the axial direction. The wrench engagement surfaces 5 and 9 can be aligned with each other. The teeth 16 and 21 are not subjected to a loading in the screwing-in operation by the screwing-in torque.

In use then the fully assembled and screwed-in connecting element 1 is subjected to a transverse loading. The transverse forces occurring can act on the screw member 2 or the securing ring 3. If they act on the screw member 2, the latter tends to rotate in the direction of rotation 25, with respect to the securing ring 3 which remains fast. The aim of this is that a slight release of the screw member 2, of its own accord, as a consequence of the high loading applied by the transverse forces, has the result that a sliding movement takes place by means of the shaped surfaces 18 and 23, that is to say, the screw member 2 rotates in the unscrewing direction relative to the securing ring 3 which is held fast by virtue of frictional engagement, and as a result the screw member 2 and the securing ring 3 are urged axially away from each other so that further release of the connecting element of its own accord is reliably avoided, due to an increase in the biasing force. This is a major safety effect.

If, in other situations, the transverse forces act on the securing ring 3, it has a tendency to rotate in the direction of rotation 25 with respect to the screw member 2 which stays fast. That is equivalent to a relative rotary movement of the screw member 2 with respect to the securing ring 3 in the direction of rotation 24. The aim of this is also that a slight loosening of the securing ring 3 of its own accord, as a consequence of a high loading due to transverse forces, has the result that a sliding movement takes place by means of the shaped surfaces 17 and 22, that is to say the securing ring 3 rotates in the unscrewing direction relative to the screw member 2 which is stationary due to frictional engagement, and as a result the screw member 2 and the securing ring 3 are urged axially away from each other so that further release of the connecting element of its own accord is reliably avoided by an increase in the biasing force. That is a major safety effect.

It is necessary for the screw member 2 and the securing ring to be rotated as a unit in the direction of rotation 25 when deliberately unscrewing the connecting element 1.

The second exemplary embodiment of the fastener 1, as shown in FIG. 5, is identical in many respects to the embodiment shown in FIGS. 1 through 4, and therefore reference may be made thereto. Here, the contact surface 15 of the securing ring 3 is of a conical configuration. The connecting element 1 with its screw member 2 and its securing ring 3 is in this case in the form of a wheel screw or bolt and serves for fixing a wheel dish to the hub of a vehicle axle. In this case also the screw member 2 and the securing ring 3 are assembled to form a non-losable assembly unit. A groove 26 is produced by rolling in the region of the shank 10 of the screw member 2 after the securing ring 3 has been fitted thereon, the groove 26 resulting in the formation of two material beads or ridges 27, in which the material of the shank 10 is displaced radially outwardly. The diameter in the region of the beads or ridges 27 is then larger than the diameter of the bore 12 in the securing ring 3. The securing ring 3 is fixed on the screw member 2 in such a way that it cannot be lost therefrom, in that fashion. The securing ring 3 however can still be turned, it can adapt to the factors involved upon assembly and in the unscrewing situation it can be turned jointly with the screw member 2. It will be appreciated that there are also other possible ways available of arranging the securing ring 3 on the screw member 2 in such a way that it is secured against loss.

FIG. 6 shows the underside of a securing ring 3 in a further embodiment. The contact surface 15 formed there is of a crowned configuration and has ribs 28 which are arranged radially and which project from the crowned contact surface 15. The function of those ribs 28 is to increase the frictional moment between the contact surface 15 and the corresponding counterpart contact surface on the wheel dish or the component, so that this frictional moment is greater than the frictional moment between the taper-surface tooth arrangements 8 and 14 in the unscrewing direction. A friction-enhancing measure can also be implemented in another fashion, for example by means of a coating, by making the roughness of the surface of the contact surface 15 in the micro-range and so forth.

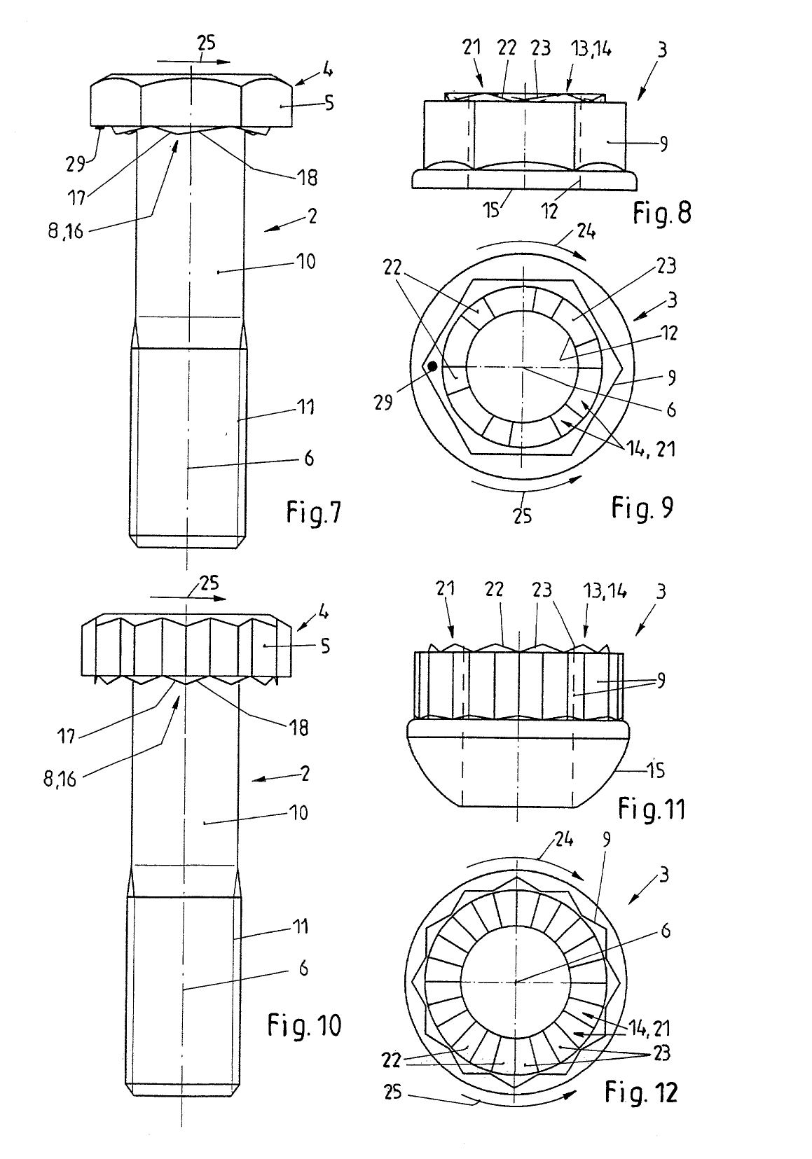

FIG. 7 illustrates another exemplary embodiment of the screw member 2, with which there is associated a securing ring 3 as is shown in FIGS. 8 and 9. The structure shown in FIGS. 7 through 9 substantially corresponds to that shown in FIGS. 2 through 4 so that reference may be made to the description in that respect. While the shaped surfaces 17 and 18 of the teeth 16 of the screw member 2 as shown in FIG. 2 were of a symmetrical configuration, the shaped surfaces 17 and 18 of the teeth 16 which form the taper-surface tooth arrangement 8 are now arranged at different inclinations, that is to say at different tangential angles. The form surfaces 18 extend at a lower slope or gradient in the peripheral direction than the form surfaces 17. The shaped surfaces 18 are therefore also of a greater extent as both shaped surfaces 17 and 18 blend together along common edges. On the securing ring 3, shaped surfaces 22 on the teeth 21 are associated with the shaped surfaces 17 of the teeth 16. The shaped surfaces 23 are correspondingly complementary to the shaped surfaces 18. In this case also the arrangement is such that the taper-surface tooth arrangements 8 and 14 fit together in six different angular positions, with the wrench engagement surfaces 5 and 9 being mutually aligned in each of those angular positions. If the wrench engagement surfaces 5 and 9 are in the form of a square instead of the illustrated hexagonal configuration, the form surfaces should also each be provided in four pairs or an integral part thereof in order to ensure the desired relative positions for joint actuation of the connecting element or fastener 1 including the screw member 2 and the securing ring 3 when tightening and unscrewing same. The screw member 2 as shown in FIG. 7 and the securing ring 3 as shown in FIG. 9 can be connected together as a pre-assembled unit by way of an adhesive spot 29 so that one of the six possible angular positions is accordingly preferred and appropriate alignment is rendered unnecessary when using the unit. The adhesive spot 29 can also serve to fix the securing ring 3 to the screw member 2 so that it is secured against loss therefrom. The adhesive force of the adhesive spot 29 should be slight, at any event so slight that it is released when transverse loadings occur, so that the above-mentioned slight relative rotational movement between the screw member 2 and the securing ring 3 and the described sliding motion can occur and are not impeded by the adhesive spot 29. Instead of using an adhesive spot 29 it is also possible to use markings (not shown) on the screw member 2 and on the securing ring 3.

Depending on the respective situation of use it may be desirable to use different slopes or gradients for the shaped surfaces 17 and 18 on the one hand and the corresponding shaped surfaces 22 and 23 on the other hand. The gradient of the shaped surfaces 18 and 23 is a determining factor in respect of the sliding movement with which the transverse forces act on the screw member 2 and thus the screw member 2 threatens to rotate in the direction of rotation 25 with respect to the stationary securing ring 3. To provide a re-tightening effect, it is necessary for the angle of inclination of the shaped surfaces 18 and 23 to be greater, but not too much greater than the pitch angle of the screwthread in the screwthread portion 11. As the described limit does not apply in respect of the tangential angles of the shaped surfaces 17 and 23, it may be appropriate for the shaped surfaces 17 and 22 to involve comparatively smaller tangential angles than the shaped surfaces 18 and 23. The reversed design configuration, insofar as shown in FIGS. 7 through 9, therefore appears particularly desirable.

FIGS. 10 through 12 show another exemplary embodiment. This view corresponds to that shown in FIGS. 2 through 4 so that reference may be made to the description in that respect. Here, the wrench engagement surfaces 5 and 9 are in the form of a regular dodecagon so that there are twelve different relative positions in which the taper-surface tooth arrangements 8 and 14 engage into each other in precise and oriented relationship. Accordingly, the number of teeth 16 and 21 and the associated shaped surfaces 17, 18 and 22, 23 is also doubled. The contact surface 15 is here of a crowned configuration so that it is possible to see that this connecting element is particularly suitable as a wheel screw or bolt.

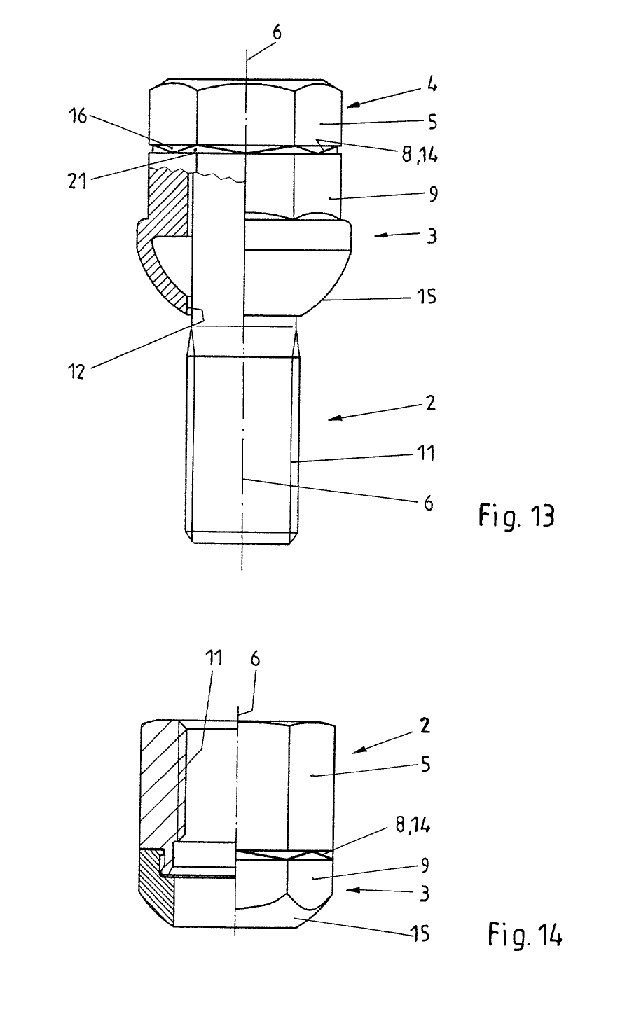

FIG. 13 shows an exemplary embodiment of the fastener 1 including a screw member 2 and a securing ring 3 with a symmetrical configuration for the teeth 16, 21 and corresponding symmetrical taper-surface tooth arrangements 8 and 14. Here the securing ring 3 is in the form of an elastic hollow body in particular in its lower part. It is thus in particular elastic in nature in the direction of the axis 6 in order to be able to take still better account of the movements involved.

FIG. 14 shows a novel connecting element or fastener in the form of a wheel nut. Here, the screw member 2 is in the form of a nut and has the first wrench engagement surface 5 and, in its interior, the threaded portion 11. The securing ring 3 is held to the screw member 2 non-losably but rotatably. The taper-surface tooth arrangements 8, 14 which are matched to each other are here again of a symmetrical configuration. The securing ring 3 has a contact surface 15 of a cambered or crowned configuration. That makes it clear that the invention can also be applied to the combination of a nut with a securing ring 3.

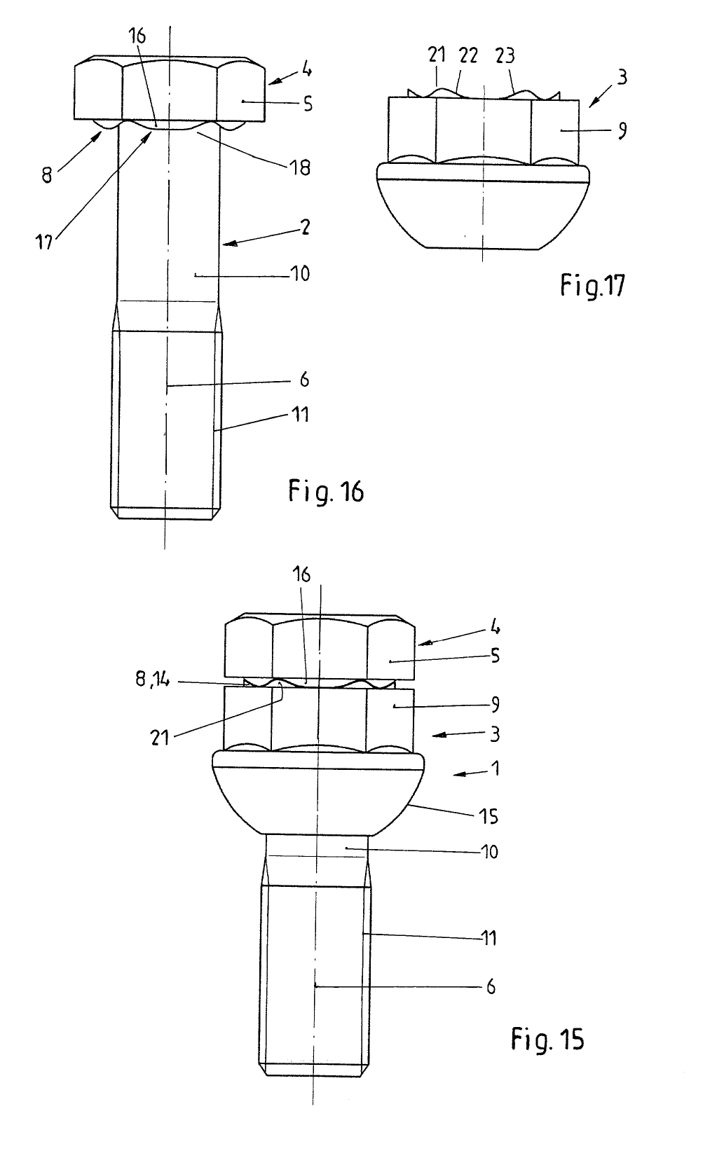

The exemplary embodiment shown in FIGS. 15 through 17 includes a connecting element or fastener 1 which once again includes a screw member 2 and a securing ring 3. The view accordingly substantially corresponds to that shown in FIGS. 1 through 3 so that reference may be made to the description in respect thereof. The configuration of the taper-surface tooth arrangements 8 and 14 is different. Thus, arranged under the head 4 of the screw member 2 are form surfaces 17 and 18 which extend arcuately in cross-section and in which therefore the tangential angle locally changes over the angle of rotation of the screw member 2. In that case, with an increasing angle of rotation, the tangential angle decreases, that is to say the slope of the shape surface 17 becomes smaller, with an increasing angle of rotation. The form surfaces 22 and 23 which together form a respective tooth 21 are of a corresponding configuration and arrangement on the securing ring 3. In this embodiment there is surface contact between the taper-surface tooth arrangements 8 and 14 only in one of the six preferred angular positions as between the screw member 2 and the securing ring 3. Each relative rotary movement results in support in point or line form.

Many variations and modifications may be made to the preferred embodiments of the invention without departing substantially from the spirit and principles of the invention. All such modifications and variations are intended to be included herein within the scope of the present invention, as defined by the following claims.

We claim:

1. A fastener, comprising:
a screw member including a first wrench engagement surface, a threaded portion and a support surface; and
a securing ring including a second wrench engagement surface, a counterpart support surface facing said screw member and a contact surface being designed and arranged to transmit an axial force to a component in the mounted position of said fastener,
said securing ring being rotatably connected to said screw member,
said support surface facing said securing ring, being designed and arranged to transmit an axial force to said securing ring and including a first taper-surface tooth arrangement being designed and arranged to be operative in both directions of rotation, and
said counterpart support surface including a respective second taper-surface tooth arrangement being designed and arranged to be operative in both directions of rotation.

2. The fastener of claim 1, wherein said first and second taper-surface tooth arrangements are designed and arranged such that, when force acts on said screw member or on said securing ring in the unscrewing direction of said fastener, there is a securing action between said screw member and said securing ring, the securing action acting against a self-releasing effect of said fastener, and said screw member and said securing ring being screwed away from each other, increasing the axial force, and said first and second taper-surface tooth arrangements maintain their positively locking engagement upon joint tightening and joint unscrewing.

3. The fastener of claim 1, wherein said first and second taper-surface tooth arrangements each include a plurality of teeth, each of said teeth in the two circumferential directions including at least two form surfaces being designed and arranged to be inclined in the circumferential directions, said form surfaces which come into contact with each other in the unscrewing direction being designed and arranged with a comparatively small mean tangential angle to permit a sliding movement which rotates said screw member and said securing ring away from each other.

4. The fastener of claim 2, wherein said first and second taper-surface tooth arrangements each include a plurality of teeth, each of said teeth in the two circumferential directions including at least two form surfaces being designed and arranged to be inclined in the circumferential directions, said form surfaces which come into contact with each other in the unscrewing direction being designed and arranged with a comparatively small mean tangential angle to permit a sliding movement which rotates said screw member and said securing ring away from each other.

5. The fastener of claim 3, wherein said threaded portion has a helix angle, and wherein the effective tangential angle of said form surfaces which come into contact with each other in the unscrewing direction is only slightly greater than the helix angle of said threaded portion.

6. The fastener of claim 4, wherein said threaded portion has a helix angle, and wherein the effective tangential angle of said form surfaces which come into contact with each other in the unscrewing direction is only slightly greater than the helix angle of said threaded portion.

7. The fastener of claim 3, wherein said threaded portion has a helix angle, and wherein the effective tangential angle of said form surfaces which come into contact with each other in the unscrewing direction is up to approximately 20 percent greater than the helix angle of said threaded portion.

8. The fastener of claim 4, wherein said threaded portion has a helix angle, and wherein the effective tangential angle of said form surfaces which come into contact with each other in the unscrewing direction is up to approximately 20 percent greater than the helix angle of said threaded portion.

9. The fastener of claim 3, wherein said form surfaces are designed and arranged to symmetric.

10. The fastener of claim 3, wherein said form surfaces are designed and arranged to asymmetric.

11. The fastener of claim 3, wherein said form surfaces which come into contact with each other to achieve the sliding movement in the unscrewing direction are designed as non-flat surfaces extending in a threaded configuration.

12. The fastener of claim 1, wherein said first and second taper-surface tooth arrangements are designed and arranged such that the torque which can be transmitted by said first and second taper-surface tooth arrangements is less than the torque which can be transmitted between said securing ring and said component in the mounted position of said fastener.

13. The fastener of claim 1, wherein said contact surface is designed and arranged such that the torque which can be transmitted by said first and second taper-surface tooth arrangements is less than the torque which can be transmitted between said securing ring and said component in the mounted position of said.

14. The fastener of claim 1, wherein said first and second taper-surface tooth arrangements and said contact surface are designed and arranged such that the torque which can be transmitted by said first and second taper-surface tooth arrangements is less than the torque which can be transmitted between said securing ring and said component in the mounted position of said fastener.

15. The fastener of claim 13, wherein said contact surface has an increased level of friction.

16. The fastener of claim 14, wherein said contact surface has an increased level of friction.

17. The fastener of claim 15, wherein said contact surface includes at least one element taken from the group consisting of a plurality of ribs, bar-like projections, a friction-enhancing coating and a sand-blasted surface.

18. The fastener of claim 16, wherein said contact surface includes at least one element taken from the group consisting of a plurality of ribs, bar-like projections, a friction-enhancing coating and a sand-blasted surface.

19. The fastener of claim 1, wherein said contact surface has a larger frictional radius than said taper-surface tooth arrangements.

20. The fastener of claim 1, wherein said securing ring is arranged on said screw member to be captive but movable.

21. The fastener of claim 1, wherein said first and second wrench engagement surfaces are designed and arranged to be in mutually aligned relationship to be commonly operable with one wrench.

22. The fastener of claim 1, wherein said screw member and said securing ring are interconnected by a spot of adhesive.

23. The fastener of claim 1, wherein said screw member is a wheel screw.
